(19) United States
(12) Patent Application Publication
(10) Pub. No.: US 2013/0128579 A1
(43) Pub. Date: May 23, 2013

(54) ILLUMINATING DEVICE

(71) Applicant: CHIH-HAO CHANG, Chu-Nan (TW)

(72) Inventor: CHIH-HAO CHANG, Chu-Nan (TW)

(73) Assignee: FOXSEMICON INTEGRATED TECHNOLOGY, INC., Chu-Nan (TW)

(21) Appl. No.: 13/300,661

(22) Filed: Nov. 21, 2011

(51) Int. Cl. F21V 29/00

(52) U.S. Cl. 362/249.01

(57) ABSTRACT

An illuminating device comprises a heat dissipating module, a light emitting module arranged on the heat dissipating module, and a holder connected to the heat dissipating module. The heat dissipating module comprises a heat conductive plate and a plurality of fins; the heat conductive plate has a first surface and a second surface opposite to the first surface; the plurality of fins are configured on the first surface and extends along a direction away from the second surface. The light emitting module comprises a base attached to the second surface of the heat dissipating module and a light source; the base has a supporting surface and the light source is arranged on the supporting surface. A distance between the supporting surface and the second surface gradually increases along a direction from one side of the heat conductive plate to the other.

### BACKGROUND

1. Technical Field

The present disclosure generally relates to illuminating devices and particularly, to an illuminating device with light field capable of being adjusted.

2. Description of Related Art

In the design of an illuminating device, light field is always major concern. Most illuminating devices generally generate butterfly-type light fields or diffusion-type light fields. However, these types of light field are not always suitable for a particular application.

Therefore, what is needed is to provide an illuminating device whose light field is adjustable.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the whole view.

FIG. 1 is an isometric view of an illuminating device in accordance with a first embodiment of the present disclosure.

FIG. 2 is an exploded view of the illuminating device of FIG. 1.

FIG. 3 is a side view of a heat dissipating module and a light emitting module of the illuminating device of FIG. 1.

FIG. 4 is a side view of a heat dissipating module and a light emitting module of an illuminating device in accordance with a second embodiment of the present disclosure.

FIG. 5 is a side view of a light emitting module of an illuminating device in accordance with a third embodiment of the present disclosure.

FIG. 6 is a side view of a light emitting module of an illuminating device in accordance with a fourth embodiment of the present disclosure.

### DETAILED DESCRIPTION

Reference will now be made to the drawing to describe the present illuminating device, in detail.

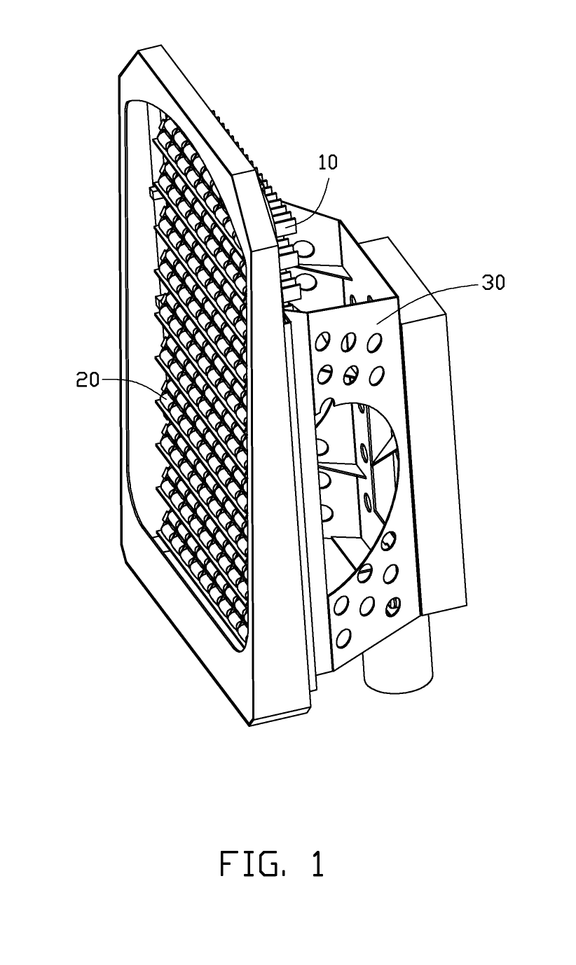

Referring to FIG. 1, an illuminating device according to the first embodiment includes a heat dissipating module 10, at least one light emitting module 20 arranged on the heat dissipating module 10, and a holder 30 connected to the heat dissipating module 10.

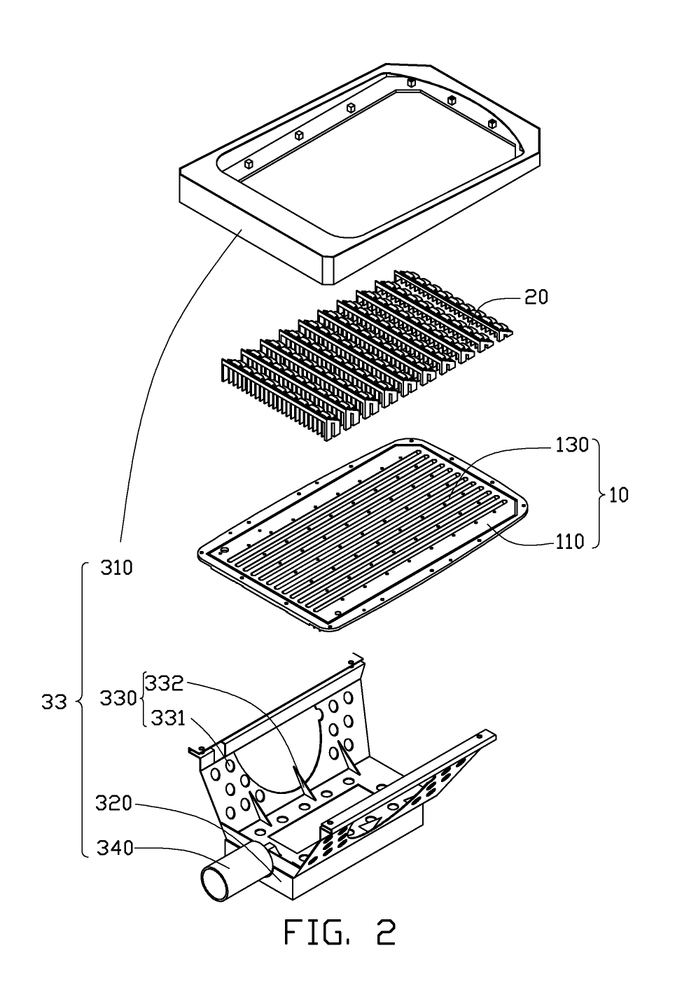

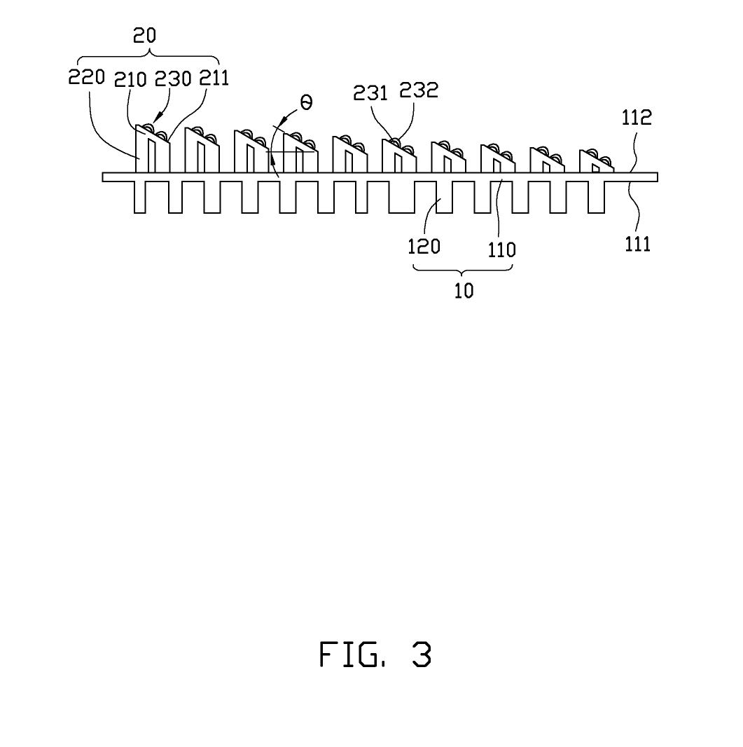

The heat dissipating module 10 can be made of metallic materials with high thermal conductivity. Referring to FIG. 2 and FIG. 3, the heat dissipating module 10 includes a heat conductive plate 110 and a plurality of fins 120 extending therefrom.

The heat conductive plate 110 basically has a shape of a planar slab. The heat conductive plate 110 includes a first surface 111 and a second surface 112 opposite to the first surface 111. In an exemplary embodiment, the second surface 112 is parallel to the first surface 111. In a further exemplary embodiment, the second surface 112 has a plurality of grooves 130 formed therein and the plurality of grooves 130 are parallel to each other. In a still further exemplary embodiment, each groove 130 has a heat pipe (not illustrated) arranged therein, in order to rapidly dissipate heat to other portions of the heat conductive plate 110.

The plurality of fins 120 are configured on the first surface 111. The plurality of fins 120 extends from the first surface 111 along a common direction away from the second surface 112. In an exemplary embodiment, the extending direction of the plurality of fins 120 is perpendicular to the first surface 111.

The light emitting module 20 is arranged on the second surface 112 of the heat conductive plate 110. The light emitting module 20 include a base 210, at least one conducting column 220 and at least one light source 230. In this embodiment, the illuminating device includes a plurality of light emitting modules 20, and the light emitting modules 20 each include a base 210, two conducting columns 220 and two light sources 230.

The base 210 of the light emitting module 20 has a wedge-like shape and includes a supporting surface 211 for supporting the two light sources 230. The supporting surface 211 is a planar surface slanting to the second surface 112 of the heat conductive plate 110. Each of included angles 0 between the supporting surfaces 211 and the second surface 112 has a range which is larger than zero and smaller than 90 degrees. In this embodiment, each of the included angles θ is equal to 30 degree. As such, a distance between each supporting surface 211 and the second surface 112 gradually increases along a first direction defined as from one side of the heat conductive plate to another side.

The heat conducting columns 220 are configured for respectively interconnecting the bases 210 and the second surface 112 of the heat conductive plate 110. The two heat conducting columns 220 of each light emitting module 20 has the same width. The heights of the heat conducting columns 220 of the light emitting modules 20 gradually increase along the first direction as defined above. In an exemplary embodiment, the heat conducting column 220 is fixed to the second surface 112 by screws. In a further exemplary embodiment, the heat conducting column 220 has an end embedded in the groove 130 of the second surface 112. In a still further exemplary embodiment, the heat conducting column 220 is thermally connected to heat pipes arranged in the grooves 130. As such, the base 210 is thermally connected to the heat pipes through the heat conducting columns 220.

Each light source 230 includes at least one light emitting element 231 and at least one optical element 232 for adjusting direction of light emitted from the light emitting element 231. The light emitting element 231 can be a light emitting diode or a laser diode. The optical element 232 can be a lens or a reflector. In this embodiment, the optical element 232 is a lens with a convex light output surface and the light emitting element 231 is received in an interior of the optical element 232.

The holder 30 includes frame 310, a power box 320 and a connecting piece 330 interconnecting the frame 310 and the power box 320.

The frame 310 basically has a rectangular shape and is hollow. The frame 310 includes a receiving space for receiving the heat conductive plate 110 and the light emitting module 20. The fins 120 extend to an exterior of the receiving space, thereby dissipating heat generated by the light emitting module 20 to the environment.

The power box 320 has a power supply received therein for driving the light emitting module 20 to emit light. The power box 320 further has a tube 340 formed at a lateral side thereof. As such, the power box 320 can be connected with exterior electric apparatus through cables passing through the tube 340.

The connecting piece 330 has a plurality of holes 331 formed thereon to achieve efficient heat dissipation. The connecting piece 330 further includes strengthening ribs 332 joining the power box 320 and an inner surface of the connecting piece 330 together. In this embodiment, each of the strengthening ribs 332 has a triangle shape with its two sides joining the power box 320 and an inner surface of the connecting piece 330.

For the above-described configuration of the illuminating device, heat generated by the light sources 230 can be transferred to the fins 120 through the base 210, the heat conducting columns 220 and the heat conductive plate 110. Light field of the illuminating device can be adjusted by setting predetermined included angle between the supporting surfaces 211 and the second surface 112. For assisting light filed adjustment, the height of each heat conducting column 220 can be correspondingly modified during fabricating process of the illuminating device, to achieve light field modification.

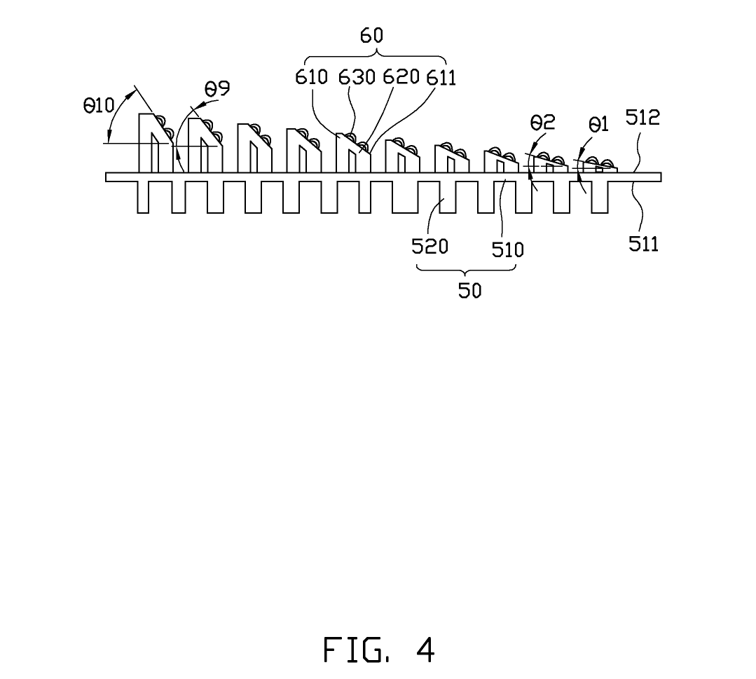

Referring to FIG. 4, a heat dissipating module 50 and a light emitting module 60 of an illuminating device in accordance with a second embodiment of the present disclosure are provided.

The heat dissipating module 50 has a configuration as the same as the above-described heat dissipating module 10. The heat dissipating module 50 also includes a heat conductive plate 510 with opposite surfaces 511 and 512, and a plurality of fins 520 formed on the surface 511.

The light emitting module 60 has a configuration basically similar to the above-described light emitting module 20. The light emitting module 60 also includes a base 610 with a slanting supporting surface 611, two conducting columns 620 interconnecting the base 610 and the surface 512, and two light sources 630 on the supporting surface 611. The included angles between the supporting surfaces 611 and the second surface 512 also range from 0 to 90 degree.

The difference between the light emitting modules 20 and 60 is that, the included angles between the supporting surfaces 611 and the second surface 512 gradually increase along a direction defined from one side (right side of FIG. 4) of the heat conductive plate 510 to another side (left side of FIG. 4). In a more detailed description, there are ten light emitting modules 60. The included angles between the supporting surfaces 611 and the second surface 512 are respectively represented as θ₁, θ₂, . . . , θ₉ and θ₁₀. The included angles θ₁, θ₂, . . . , θ₉ and θ₁₀ satisfy condition: θ₁<θ₂< . . . <θ₉<θ₁₀, as illustrated in FIG. 4.

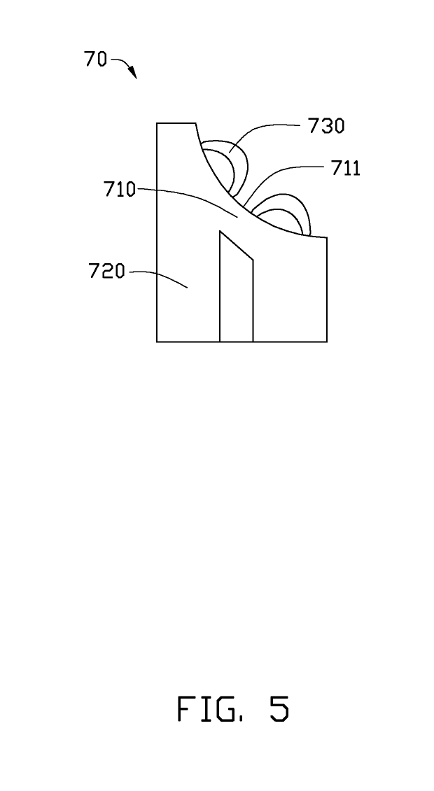

Referring to FIG. 5, a light emitting module 70 of an illuminating device in accordance with a third embodiment of the present disclosure is provided. The light emitting module 70 has a configuration basically similar to the light emitting module 20. The light emitting module 70 also includes a base 710 with a supporting surface 711, two conducting columns 720, and two light sources 730 on the supporting surface 711. The difference between the light emitting modules 20 and 70 is that, the supporting surface 711 is a concave surface which can also achieve light modification of light field of the illuminating device. It is to be said that, the supporting surface 711 of the light emitting module can also be a convex surface instead.

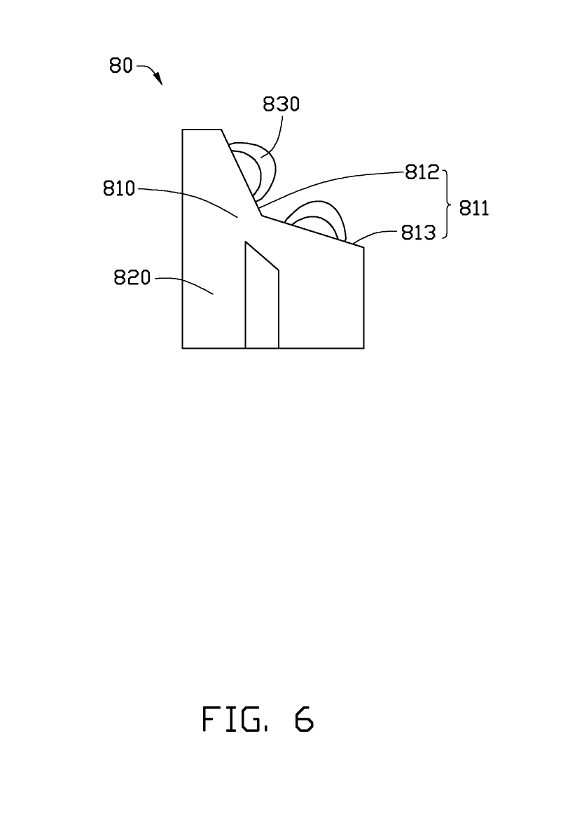

Referring to FIG. 6, a light emitting module 80 of an illuminating device in accordance with a fourth embodiment of the present disclosure is provided. The light emitting module 80 has a configuration basically similar to the light emitting module 20. The light emitting module 80 also includes a base 810 with a supporting surface 811, two conducting columns 820, and two light sources 830 on the supporting surface 811. The difference between the light emitting modules 20 and 80 is that, the supporting surface 811 consists of two slanting surfaces 812, 813 with different slopes.

It is to be understood that the above-described embodiments are intended to illustrate rather than limit the disclosure. Variations may be made to the embodiments without departing from the spirit of the disclosure as claimed. The above-described embodiments illustrate the scope of the disclosure but do not restrict the scope of the disclosure.

What is claimed is:

1. An illuminating device comprising:
a heat dissipating module, at least one light emitting module arranged on the heat dissipating module, and a holder connected to the heat dissipating module:
wherein the heat dissipating module comprises a heat conductive plate and a plurality of fins, the heat conductive plate has a first surface and a second surface opposite to the first surface, the plurality of fins are configured on the first surface and extends along a direction away from the second surface;
wherein the at least one light emitting module comprises a base attached to the second surface of the heat dissipating module and a light source, the base has a supporting surface and the light source is arranged on the supporting surface; and
wherein a distance between the supporting surface of the base of the light emitting module and the second surface of the heat conductive plate gradually increases along a first direction from one side of the heat conductive plate to another.

2. The illuminating device according to claim 1, wherein the at least one light emitting module further comprises at least one heat conductive column interconnecting the base and the second surface, the at least one heat conductive column has a height gradually increases along the first direction.

3. The illuminating device according to claim 1, wherein the light source comprises a light emitting element and an optical element for adjusting direction of light emitted from the light emitting element.

4. The illuminating device according to claim 1, wherein the at least one light emitting module comprises a plurality of light emitting modules aligned on the second surface in a matrix.

5. The illuminating device according to claim 4, wherein each supporting surface of the light emitting modules is a planar surface, and an included angle between each supporting surface and the second surface ranges from 0 to 90 degree.

6. The illuminating device according to claim 5, wherein all included angles between the supporting surfaces and the second surface are the same.

7. The illuminating device according to claim 5, wherein the included angles between the supporting surfaces and the second surface are increased gradually along the first direction with the same interval between each two neighboring supporting surfaces.

8. The illuminating device according to claim 1, wherein the supporting surface is a concave surface.

9. The illuminating device according to claim 1, wherein the heat conductive plate comprises a plurality of grooves in the second surface, the grooves are parallel to each other, each of the grooves has a heat pipe received therein, and the heat pipes are thermally conductive to the at least one light emitting module.

10. The illuminating device according to claim 1, wherein the holder comprises a frame, a power box and a connecting piece, the power box is connected to the frame by the connecting piece, the heat dissipating module and the light emitting module are received in the frame.
